(19) United States
(12) Patent Application Publication
(10) Pub. No.: US 2025/0168923 A1
(43) Pub. Date: May 22, 2025

(54) ELECTRONIC DEVICE, METHOD AND STORAGE MEDIUM FOR WIRELESS COMMUNICATION

(71) Applicant: Sony Group Corporation, Tokyo (JP)

(72) Inventor: Tingting FAN, Beijing (CN)

(73) Assignee: Sony Group Corporation, Tokyo (JP)

(21) Appl. No.: 18/836,771

(22) PCT Filed: Feb. 23, 2023
(86) PCT No.: PCT/CN2023/077877

§ 371 Date: Aug. 8, 2024

(30) Foreign Application Priority Data
Feb. 28, 2022 (CN) 202210185985.4

(51) Int. Cl. H04W 76/28; H04W 72/0446

(52) U.S. Cl. CPC H04W 76/28; H04W 72/0446

(57) ABSTRACT

The present disclosure relates to an electronic device, method and a storage medium for wireless communication. Described are various embodiments for energy saving of a terminal device. In an embodiment, an electronic device comprises a processing circuit, and the processing circuit is configured to: provide a first discontinuous reception (DRX) configuration to a terminal device, wherein the first DRX configuration is used for enabling the terminal device to activate and sleep with a first set of DRX parameters; and provide a second DRX configuration to the terminal device during an activation duration of the terminal device based on the first set of DRX parameters, wherein the second DRX configuration is used for enabling the terminal device to sleep with a second set of DRX parameters during the activation duration.

### TECHNICAL FIELD

The present disclosure generally relates to a device and method for wireless communication, including technologies for enhancing power saving of terminal devices through an improved Discontinuous Reception (DRX) mechanism.

### BACKGROUND

A DRX mechanism is introduced to wireless communication systems such as long term evolution (LTE) and new radio (NR), to implement power saving for terminal devices. In the DRX mechanism, the terminal device may periodically enter a sleep state and does not perform Physical Downlink Control Channel (PDCCH) monitoring in the sleep state. When it is needed to monitor the PDCCH, the terminal device wakes up from the sleep state and enters an active state.

In the DRX mechanism, it is desired for the terminal device to achieve power saving through sleeping, while not affecting transmission of service data as much as possible. With emergence of new services such as Extended Reality (XR), it is expected to improve or adjust the DRX mechanism to enhance power saving for terminal devices.

### SUMMARY

A first aspect of the present disclosure relates to an electronic device for a base station side. The electronic device includes a processing circuit configured to: provide a first DRX configuration to a terminal device, the first DRX configuration being used to cause the terminal device to activate and sleep with a first set of DRX parameters; and during an activation duration of the terminal device based on the first set of DRX parameters, provide a second DRX configuration to the terminal device, the second DRX configuration being used to cause the terminal device to sleep with a second set of DRX parameters during the activation duration.

A second aspect of the present disclosure relates to an electronic device for a terminal device side. The electronic device includes a processing circuit configured to: receive a first DRX configuration, the first DRX configuration being used to cause a terminal device to activate and sleep with a first set of DRX parameters; receive a second DRX configuration during an activation duration based on the first set of DRX parameters; and sleep with a second set of DRX parameters during the activation duration.

A third aspect of the present disclosure relates to a communication method including: providing a first DRX configuration to a terminal device, the first DRX configuration being used to cause the terminal device to activate and sleep with a first set of DRX parameters; and during an activation duration of the terminal device based on the first set of DRX parameters, providing a second DRX configuration to the terminal device, the second DRX configuration being used to cause the terminal device to sleep with a second set of DRX parameters during the activation duration.

A fourth aspect of the present disclosure relates to a communication method including: receiving a first DRX configuration, the first DRX configuration being used to cause a terminal device to activate and sleep with a first set of DRX parameters; receiving a second DRX configuration during an activation duration based on the first set of DRX parameters; and sleeping with a second set of DRX parameters during the activation duration.

A fifth aspect of the present disclosure relates to a computer-readable storage medium having executable instructions stored thereon, which executable instructions, when executed by one or more processors, cause implementation of operations of the method according to various embodiments in the present disclosure.

A sixth aspect of the present disclosure relates to a computer program product, where the computer program product includes instructions which, when executed by a computer, cause implementation of the method according to various embodiments in the present disclosure.

The above summary is provided to summarize some exemplary embodiments in order to provide a basic understanding of the various aspects of the subject matter described herein. Therefore, the above-described features are merely examples and should not be construed as limiting the scope or spirit of the subject matter described herein in any way. Other features, aspects, and advantages of the subject matter described herein will become apparent from the Detailed Description described below in conjunction with the drawings.

### BRIEF DESCRIPTION OF DRAWINGS

A better understanding of the present disclosure can be achieved by referring to the detailed description given hereinafter in connection with the accompanying drawings. The same or similar reference numerals are used in the accompanying drawings to denote the same or similar components. The accompanying drawings together with the following detailed description are included in the specification and form a part of the specification, and are used to exemplify the embodiments of the present disclosure and explain the principles and advantages of the present disclosure, where:

FIG. 1 illustrates an example block diagram of a communication system according to an embodiment of the present disclosure.

FIG. 2A illustrates an example DRX process and a corresponding receiver state of a terminal device.

FIG. 2B illustrates an example DRX process and a corresponding receiver state of a terminal device according to an embodiment of the present disclosure.

FIG. 3A illustrates an example electronic device which may implement a base station according to an embodiment of the present disclosure.

FIG. 3B illustrates an example electronic device which may implementing a terminal device according to an embodiment of the present disclosure.

FIG. 4 illustrates an example signaling process for DRX configuration according to an embodiment of the present disclosure.

FIGS. 5 and 6 illustrate examples of providing sub-DRX configurations through DCI according to an embodiment of the present disclosure.

FIG. 7A illustrates an example application of a sub-DRX mechanism according to an embodiment of the present disclosure.

FIG. 7B illustrates specific operations of a base station and a terminal device corresponding to FIG. 7A.

FIG. 8A and FIG. 8B illustrate an example method for communication according to an embodiment of the present disclosure.

FIG. 9 is an example block diagram of a computer capable of being implemented as a terminal device or base station according to an embodiment of the present disclosure.

FIG. 10 is a block diagram illustrating a first example of a schematic configuration of a gNB to which the technology of the present disclosure can be applied.

FIG. 11 is a block diagram illustrating a second example of a schematic configuration of a gNB to which the technology of the present disclosure can be applied

FIG. 12 is a block diagram illustrating an example of a schematic configuration of a smartphone which can apply the technology of the present disclosure.

FIG. 13 is a block diagram illustrating an example of a schematic configuration of a car navigation device which can apply the technology of the present disclosure.

Although the embodiments described in the present disclosure may have various modifications and alternatives, specific embodiments thereof are illustrated as examples in the accompany drawings and described in detail in this specification. It should be understood that the drawings and detailed description thereof are not intended to limit embodiments to the specific forms disclosed, but to cover all modifications, equivalents, and alternatives falling within the spirit and scope of the claims.

### DESCRIPTION OF EMBODIMENTS

The following describes representative applications of various aspects of the device and method according to the present disclosure. The description of these examples is merely to add context and help to understand the described embodiments. Therefore, it is clear to those skilled in the art that the embodiments described below can be implemented without some or all of the specific details. In other instances, well-known process steps have not been described in detail to avoid unnecessarily obscuring the described embodiments. Other applications are also possible, and the solution of the present disclosure is not limited to these examples.

Generally, all terms used herein will be interpreted in accordance with their ordinary meaning in the related art, unless different meanings and/or implications are clearly given in the context. Unless otherwise expressly stated, references to elements, apparatuses, components, units, and operations are intended to be interpreted openly as at least one instance of the elements, the apparatuses, the components, the units, and the operations. Operations of any method disclosed herein need not be performed in the exact order disclosed unless the operations are explicitly or implicitly described after or before another operation. Any feature of any embodiment disclosed herein may be applied to any other suitable embodiment. Similarly, any advantage of any embodiment may be applied to any other embodiment, and vice versa. Other objects, features, and advantages of the embodiments will become apparent from the following descriptions.

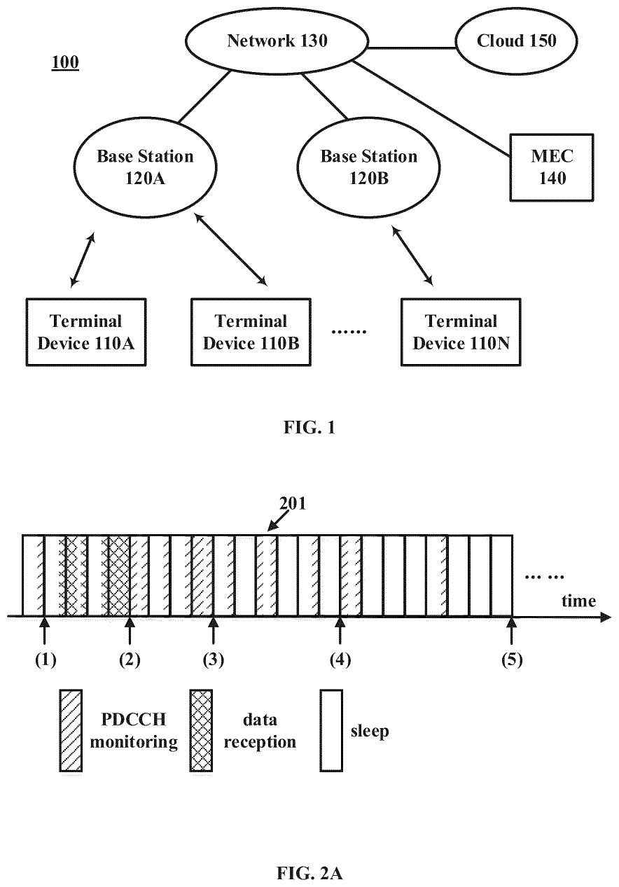

FIG. 1 illustrates an example block diagram of a communication system according to an embodiment of the present disclosure. It should be noted that FIG. 1 illustrates only one of multiple types and possible layouts of communication systems, and features of the present disclosure can be implemented in any one of the various systems as desired.

As shown in FIG. 1, the communication system 100 includes base stations 120A and 120B, and terminals 110A, and 110B to 110N. The base stations and the terminals may be configured to perform uplink and downlink communication through Uu interface. The base stations 120A and 120B may be configured to communicate with a network 130 (for example, a core network of a cellular service provider, a telecommunications network such as a public switched telephone network (PSTN), and/or the Internet). Therefore, the base stations 120A and 120B may facilitate communication between the terminals 110A to 110N and/or communication between the terminals 110A to 110N and the network 130. Further, the terminal devices 110A to 110N may perform SL communication within an effective communication range through PC5 interface.

In FIG. 1, coverage areas of the base stations 120A and 120B may be referred to as cells. Base stations operating based on one or more cellular communication technologies may provide continuous or nearly continuous communication signal coverage to the terminals 110A to 110N over a wide geographic area.

As shown in FIG. 1, the communication system 100 includes a cloud 150 and a mobile edge computing node (MEC) 140. The cloud 150 may provide services such as IaaS, PaaS, and SaaS to the terminal devices through a connection to the network 130. In the cloud 150 and the MEC 140, computing resources may be deployed to provide support for meeting computing requirements of communication services (such as communication computing convergence services).

In the present disclosure, the base station can be a 5G NR base station, such as gNB and ng-eNB. The gNB can provide NR user plane and control plane protocols for terminating with the terminal device. The ng-eNB is a node defined for compatibility with the 4G LTE communication system, which can be an upgrade of an evolved NodeB (eNB) of an LTE radio access network, providing an evolved universal terrestrial radio access (E-UTRA) user plane and control plane protocols for terminating with UEs. In addition, examples of the base station can include but are not limited to the following: at least one of a base transceiver station (BTS) or a base station controller (BSC) in a GSM system; at least one of a radio network controller (RNC) or a Node B in a WCDMA system; access points (APs) in WLAN and WiMAX systems; and corresponding network nodes in communication systems to be developed or under development. Part of functions of a base station herein can also be implemented as an entity that has control functions to communication in D2D, M2M, and V2X communication scenarios, or as an entity that plays a role of spectrum coordination in the cognitive radio communication scenario.

In the present disclosure, the terminal device can have the full breadth of its ordinary meanings, for example, the terminal device can be a mobile station (MS), user equipment (UE), an access node, and so on. The terminal device can be implemented as a device such as a mobile phone, a handheld device, a media player, a computer, a laptop computer, a tablet computer, an in-vehicle unit, a vehicle, or a wireless device of almost any type. In some cases, the terminal device can communicate using multiple wireless communication technologies. For example, the terminal device can be configured to communicate using one or more of GSM, UMTS, CDMA2000, WiMAX, LTE, LTE-A, WLAN, NR, Bluetooth, and so on. It should be understood that the embodiments described in the present disclosure are applicable to any type of terminal device.

The purpose of the DRX mechanism is to enable the terminal device to sleep regularly and stop physical downlink control channel (PDCCH) monitoring during a sleep period, thereby reducing power consumption related to PDCCH monitoring for the terminal device. Based on radio resource control (RRC) layer connectivity, DRX may include idle mode (IDLE) DRX and connected mode (CONNECTED) DRX, namely, C-DRX.

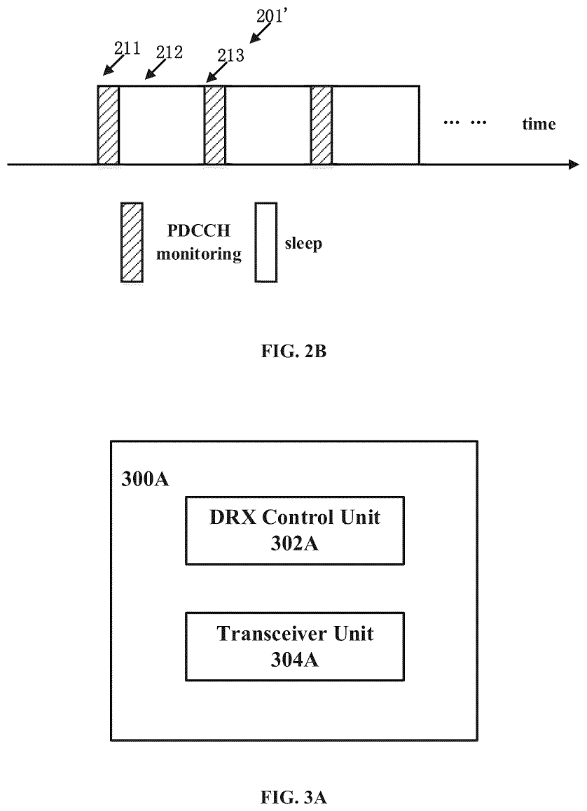

FIG. 2A illustrates an example DRX process and a corresponding receiver state of a terminal device. In FIG. 2A, each rectangle in a time axis direction represents one time unit. For example, the time unit may correspond to one or more consecutive transmission time intervals (TTI), slots, symbols (such as OFDM symbols), subframes, or the like. A slot may be a full slot or a mini-slot, and the mini-slot may include less than 14 OFDM symbols, such as 2, 3, 4, 5, 6, 7, 8, 9, 10, 11, 12, or 13 OFDM symbols. FIG. 2A illustrates at the bottom legends corresponding to PDCCH monitoring, data reception, and sleep of the terminal device to represent operations of a receiver of the terminal device at corresponding times.

As shown in FIG. 2A, after learning arrival of data transmission through PDCCH monitoring, the terminal device starts at (1) to receive data transmission until (2). At (2), data transmission ends and a DRX inactivity timer runs. Generally, the DRX inactivity timer may specify a number of consecutive PDCCH subframes following successful decoding of a PDCCH indicating uplink or downlink data transmission. If the PDCCH in the consecutive PDCCH subframes does not indicate data transmission, the terminal device may sleep through the DRX mechanism. In this example, the PDCCH during a period from (2) to (3) indicates no data transmission, and the DRX inactivity timer expires at (3). After that, the terminal device starts sleeping based on a short DRX cycle. During the short DRX cycle, the terminal device first monitors the PDCCH during an activation duration (On Duration), and enters sleep after the activation duration expires if the PDCCH does not indicate data transmission. During sleep, the terminal device does not monitor the PDCCH to achieve power saving. (3) to (4) may correspond to a plurality of short DRX cycles. If the PDCCH does not indicate data transmission during this period, the terminal device sleeps based on a long DRX cyclestarting from (4). During the long DRX cycle, similarly, the terminal device first monitors the PDCCH during one activation duration, and enters sleep after the activation duration expires if the PDCCH does not indicate data transmission. During the long DRX cycle, the terminal device may have more time to sleep, achieving better power saving effects compared with the short DRX cycle. It should be understood that the number of time units in FIG. 2A is only illustrative, and it is not limited in the present disclosure in this regard.

FIG. 2B illustrates an example DRX process and a corresponding receiver state of a terminal device according to an embodiment of the present disclosure. In embodiments of the present disclosure, the terminal device may perform additional sleep during an activation duration of DRX based on a configured DRX mechanism. In this manner, the terminal device may achieve greater energy saving.

As shown in FIG. 2B, the activation duration 201′ is an enlarged view in the time dimension of one activation duration 201 of the short DRX cycle in FIG. 2A. During the activation duration 201, the terminal device originally needs to keep monitoring the PDCCH. However, during the activation duration 201′, the terminal device may enter sleep during a part of the time 201′ based on configuration information. In one example, the configuration information may be received by the terminal device during a time 211.

In the present disclosure, DRX in FIG. 2A may be considered as a first-level DRX mechanism, and DRX within the activation duration 201 of the first-level DRX in FIG. 2B may be considered as a second-level DRX mechanism, or may be referred to as sub-DRX. FIG. 2A just illustrates one possible first-level DRX; the first-level DRX may be any type of DRX that is existing, is being developed, or appears in the future. Sub-DRX according to the embodiments of the present disclosure may be applied on the basis of any DRX.

In the embodiments of the present disclosure, during the activation duration of the first-level DRX, the base station may determine, based on corresponding characteristics of service data, that no data transmission may arrive within a period of time. Accordingly, the base station may provide configuration information (for example, including fine-grained sleep settings) to the terminal device through the PDCCH, so that the terminal device enters additional sleep during the activation duration. As shown in FIG. 2B, after an additional sleep period, the terminal device may wake up to monitor the PDCCH.

A sub-DRX configuration may be defined within the activation duration 201 of the first-level DRX, which includes one sleep duration (corresponding to time 212) and a sub-DRX cycle (corresponding to a sum of time 212 and time 213). The time 213 for PDCCH monitoring may have a default length, such as 1 ms. Similar to the first-level DRX, the sub-DRX configuration may also have long and short DRX cycles.

In the example of FIG. 2B, with the sub-DRX mechanism, the terminal device may have more and flexible sleep occasions. For services with variable packet sizes and relatively high latency requirements (such as XR services), the sub-DRX mechanism may achieve more energy saving while meeting latency requirements for service data transmission.

### Examples of the Electronic Device

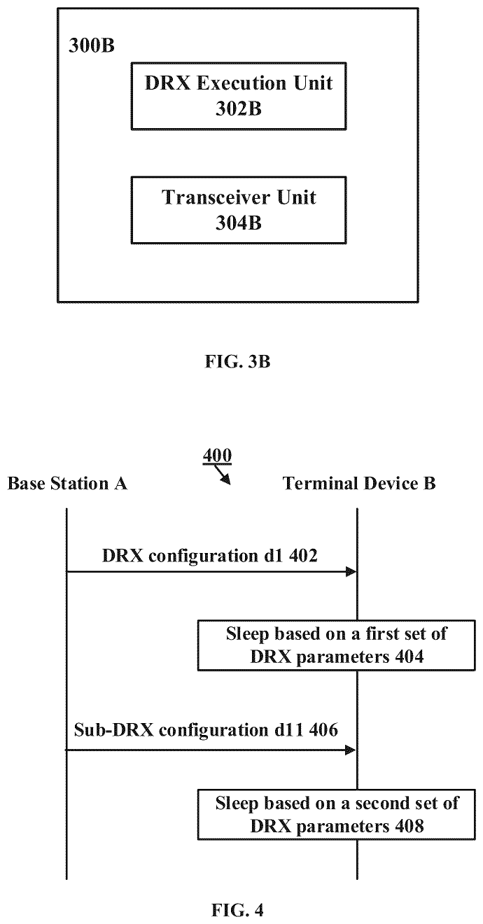

FIG. 3A illustrates an example electronic device which may implement a base station according to an embodiment of the present disclosure. The electronic device 300 may include various units to implement the embodiments of DRX control according to the present disclosure. In the example of FIG. 3A, the electronic device 300A includes a DRX control unit 302A and a transceiver unit 304A. Operations described below in conjunction with the base station or DRX control may be implemented by the units 302A and 304A of the electronic device 300A or other possible units.

In an embodiment, the DRX control unit 302A may be configured to provide a first DRX configuration to a terminal device through the transceiver unit 304A. The first DRX configuration is used to cause the terminal device to activate and/or sleep with a first set of DRX parameters. In an embodiment, the DRX control unit 302A may further be configured to provide a second DRX configuration (for example, a sub-DRX configuration) to the terminal device through the transceiver unit 304A during an activation duration of the terminal device based on the first set of DRX parameters. The second DRX configuration is used to cause the terminal device to sleep with a second set of DRX parameters during an activation duration based on the first DRX configuration.

In an embodiment, the transceiver unit 304A may be configured to control or perform operations related to transmission and reception of signaling or messages.

In embodiments, the electronic device 300A may be implemented at the chip level, or may be implemented at the device level by including other external components (such as wired or wireless links). The electronic device 300A may work as a communication device as a whole machine.

FIG. 3B illustrates an example electronic device which may implement a terminal device according to an embodiment of the present disclosure. The electronic device 300B may include various units to implement the embodiments of DRX execution according to the present disclosure. In the example of FIG. 3B, the electronic device 300B includes a DRX execution unit 302B and a transceiver unit 304B. Operations described below in conjunction with the terminal device or DRX execution may be implemented by the units 302B and 304B of the electronic device 300B or other possible units.

In an embodiment, the transceiver unit 304B may be configured to receive a first DRX configuration, where the first DRX configuration is used to cause the terminal device to activate and sleep with a first set of DRX parameters. In an embodiment, the transceiver unit 304B may be configured to receive a second DRX configuration (for example, a sub-DRX configuration) during an activation duration based on the first set of DRX parameters. The transceiver unit 304B may be further configured to control or perform operations related to transmission and reception of signaling or messages.

In an embodiment, the DRX execution unit 302B may be configured to activate and/or sleep with a first set of DRX parameters. In an embodiment, the DRX execution unit 302B may be further configured to sleep with a second set of DRX parameters during an activation duration based on the first DRX configuration.

In embodiments, the electronic device 300B may be implemented at the chip level, or may be implemented at the device level by including other external components (such as radio links and antennas). The electronic device 300B may work as a communication device as a whole machine.

It should be understood that the above various units are only logical modules divided based on logical functions to be implemented by the units, and are not intended to limit specific implementations, for example, the units can be implemented by software, hardware, or a combination of software and hardware. In actual implementation, the above various units can be implemented as independent physical entities, or can be implemented by a single entity (for example, a processor (CPU, DSP, or the like), or an integrated circuit). The processing circuitry can refer to various implementations of a digital circuitry, an analog circuitry, or a mixed signal (combination of analog and digital) circuitry that perform functions in a computing system. The processing circuitry can include, for example, a circuit such as an integrated circuit (IC), an application specific integrated circuit (ASIC), a portion or circuit of a separate processor core, the entire processor core, a separate processor, a programmable hardware device such as a field programmable gate array (FPGA), and/or a system including multiple processors.

FIG. 4 illustrates an example signaling process 400 for DRX configuration according to an embodiment of the present disclosure. The signaling process 400 may be performed between a base station (for example, an electronic device 300A) and one or more terminal devices (for example, an electronic device 300B).

As shown in FIG. 4, at 402, a base station A may provide a DRX configuration d1 to a terminal device B. The DRX configuration d1 may provide a set of DRX parameters to cause the terminal device to activate and/or sleep. Upon receiving the DRX configuration d1, at 404, the terminal device B may activate and/or sleep with the set of DRX parameters, thereby reducing power consumption related to control channel monitoring.

In an embodiment, the base station A may provide just one DRX configuration to the terminal device B through higher layer signaling (such as RRC layer signaling); and the terminal device B may operate based on a corresponding set of DRX parameters. For example, the first DRX configuration may be initially provided through RRC layer signaling. When the DRX configuration needs to be changed, a changed second DRX configuration may be provided through RRC layer signaling. Accordingly, the terminal device B may switch from an operation based on one set of DRX parameters to an operation based on another set of DRX parameters.

In an embodiment, the base station A may provide a plurality of DRX configurations to the terminal device B through higher layer signaling (such as RRC layer signaling), and the base station A activates one or more DRX configurations through layer 2 signaling (such as a MAC CE), and indicates one activated DRX configuration to the terminal device B through layer 1 signaling (such as DCI); and the terminal device B may perform an operation based on a corresponding set of activated DRX parameters. For example, a first DRX configuration, a second DRX configuration, and a third DRX configuration may be provided through RRC layer signaling, the first DRX configuration and the third DRX configuration may be activated through a MAC CE, and the activated first DRX configuration may be indicated to the terminal device B through DCI. Accordingly, the terminal device B may learn that there are three DRX configurations, of which two DRX configurations have been activated, and performs an operation based on DRX parameters corresponding to the first DRX configuration indicated by the DCI. Further, when a DRX configuration needs to be changed, the above operations may be repeated through higher layer signaling, layer 1 signaling, or layer 2 signaling. In an embodiment, the DCI may include a wakeup signal (WUS) or other appropriate DCI.

At 406, the base station A may provide a sub-DRX configuration d11 to the terminal device B during an activation duration based on the DRX configuration d1. The sub-DRX configuration d11 may provide a set of sub-DRX parameters, so that the terminal device sleeps during the activation duration of the DRX configuration d1. Upon receiving the sub-DRX configuration d11 during the activation duration based on the DRX configuration d1, the terminal device B may sleep with this set of sub-DRX parameters, thereby further reducing energy consumption related to control channel monitoring during the foregoing activation duration.

In an embodiment, the base station A may provide a plurality of sub-DRX configurations to the terminal device B through higher layer signaling (such as RRC layer signaling), and the base station A activates one or more sub-DRX configurations through layer 2 signaling (such as a MAC CE), and indicates one activated sub-DRX configuration to the terminal device B through layer 1 signaling (such as DCI); and the terminal device B may perform an operation based on a corresponding set of sub-DRX parameters. For example, a first sub-DRX configuration, a second sub-DRX configuration, and a third sub-DRX configuration may be provided through RRC layer signaling, the first sub-DRX configuration and the second sub-DRX configuration may be activated through a MAC CE, and the activated first sub-DRX configuration may be indicated to the terminal device B through DCI. Accordingly, the terminal device B may learn that there are three sub-DRX configurations, of which two sub-DRX configurations have been activated, and performs an operation based on sub-DRX parameters corresponding to the first sub-DRX configuration indicated by the DCI. Further, when a sub-DRX configuration needs to be changed, the above operations may be repeated through higher layer signaling, layer 1 signaling, or layer 2 signaling. In an embodiment, a sub-DRX configuration may be indicated by one or more bits in DCI.

In an embodiment, the base station A may provide just one sub-DRX configuration to the terminal device B through lower layer signaling (such as DCI); and the terminal device B may operate based on a corresponding set of sub-DRX parameters. For example, the first sub-DRX configuration may be initially provided through RRC layer signaling. When the sub-DRX configuration needs to be changed, a changed second sub-DRX configuration may be provided through DCI. Accordingly, the terminal device B may switch from an operation based on one set of sub-DRX parameters to an operation based on another set of sub-DRX parameters.

In some embodiments, there may be prerequisites for decoding a DRX configuration or sub-DRX configuration from the DCI by the terminal device. For example, while or after one or more DRX configurations or sub-DRX configurations are provided through higher layer signaling or lower layer signaling (such as DCI), the network side (such as the base station) further needs to indicate that a corresponding configuration has been enabled. Enablement may be indicated by higher layer signaling (for example, at the time of providing the DRX configuration or sub-DRX configuration), and/or may be indicated by lower layer signaling such as DCI (for example, at the time of indicating the DRX configuration or sub-DRX configuration).

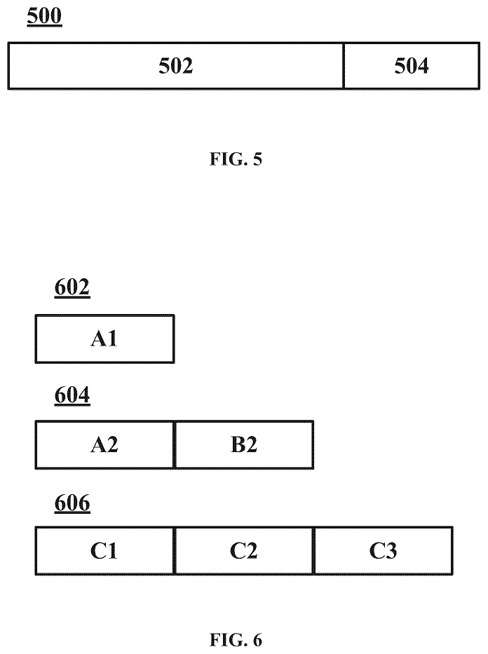

In embodiments of the present disclosure, the DRX configuration or sub-DRX configuration in the signaling may carry a corresponding DRX parameter per se or identification information of a corresponding DRX parameter. The identification information may indicate one set of parameters from a plurality of sets of DRX parameters provided by the base station. As an example, an example of providing a sub-DRX configuration through DCI according to an embodiment of the present disclosure is described below with reference to FIGS. 5 and 6.

As shown in FIG. 5, an example DCI format 500 includes a first part 502 and a second part 504, each part including one or more bits. In an example, the second part 504 is a reserved bit in the DCI format 500, and a sub-DRX configuration may be indicated by using the reserved bit (for example, indicating a sub-DRX parameter per se or identification information of the sub-DRX parameter). In an example, a bit may be added to the DCI format 500, and a sub-DRX configuration may be indicated by the added bit. In some embodiments, the sub-DRX configuration may include two DRX parameters: a sleep duration (inactive duration) and a sub-DRX cycle. During the sub-DRX cycle, the terminal device enters sleep during the sleep duration and wakes up in the rest of the time to monitor the PDCCH. Specifically, depending on whether the monitoring capability of the terminal device is slot-based, mini-slot-based, or multi-slot-based, the terminal device may choose to enter the sleep duration of the sub-DRX starting from end of a CORESET of a current slot, or end of the current slot, or end of a current multi-slot, and after the duration elapses, automatically switches to an active state. Similar to the first-level long and short DRX cycles in FIG. 2A, long and short sub-DRX cycles may also be configured. In some embodiments, the sub-DRX configuration may further include an offset value indicating an offset time from receiving a sub-DRX parameter to entering sleep. For example, an offset time being 0 may indicate the device to enter sleep immediately based on the monitoring capability; and an offset time being 1 slot may indicate entering sleep after one slot. In some embodiments, the sub-DRX configuration may also include a number of times for sleep, which indicates the number of times for sleep based on the sleep duration or sub-DRX cycle.

In another example, the second part 504 is a used bit in the DCI format 500 and a sub-DRX configuration may be indirectly indicated by using the used bit. For example, the used bit itself may indicate time domain resource allocation (TDRA) information. The time domain resource allocation information indicates that the terminal device needs to receive or send data during a specific number of symbols, slots, or the like. The terminal device may further determine, based on such information, that PDCCH monitoring is not required during this period of time, and therefore enters sleep during this period of time. Using an NR system as an example, the terminal device may use a TDRA field (for example, 5 bits) in DCI format 1-0 or DCI format 1-1 to look up a table to learn a time domain resource (for example, 4 slots) allocated to the PDSCH. In this case, the terminal device may consider the 4 slots as the sleep duration of the sub-DRX. In some embodiments, the used bit may alternatively be used to indicate an offset value in the sub-DRX configuration, which indicates an offset time from receiving a sub-DRX parameter to entering sleep.

FIG. 6 illustrates an example format of providing sub-DRX configurations according to an embodiment of the present disclosure.

As shown in FIG. 6, in an example format 602, at least one of a sleep duration or a sub-DRX cycle is indicated by a field A1. Because a sum of the sleep duration and a wake-up time for PDCCH monitoring is equal to a sub-DRX cycle, and generally, the time for PDCCH monitoring may have a default value, the other can be inferred by indicating one of the sleep duration or the sub-DRX cycle. In an example, the sub-DRX configuration is for one time, that is, the terminal device is indicated to sleep once based on the sleep duration. In an example, the sub-DRX configuration is persistent (until being overwritten by a new configuration), that is, the terminal device is indicated to sleep multiple times based on the sleep duration.

As shown in FIG. 6, in an example format 604, at least one of a sleep duration or a sub-DRX cycle is indicated by a field A2, and the number of repetitions for the sub-DRX configuration is indicated by a field B2. In an example, through the format 604, the terminal device may be indicated to sleep for a corresponding number of times based on the sleep duration. In other cases, the sub-DRX configuration may alternatively be overwritten by a new configuration before being completed for the number of repetitions.

As shown in FIG. 6, in an example format 606, a plurality of sub-DRX configurations are indicated by fields C1 to C3. Each sub-DRX configuration corresponds to at least one of a sleep duration or a sub-DRX cycle, the plurality of configurations may be the same or different. In an example, based on the format 606, the terminal device may be indicated, on a sleep duration-by-sleep duration basis, to sleep. Likewise, the sub-DRX configuration may be overwritten by the new configuration before all sleeps are completed.

In the above example formats, an advantage of the format 602 at least lies in flexibility, enabling the sleep duration to be configured in a way that matches service data transmission in real time. In the format 604, a plurality of same sub-DRX configurations are configured through single signaling, which has an advantage of at least reduced signaling. In the format 606, during configuration of a plurality of sub-DRX configurations through single signaling, a plurality of sleep durations may be different from each other, thus achieving a balance between flexibility and reduced signaling. In an embodiment, an additional field (not shown) may be added to the formats 602 to 606 to indicate an offset value for entering sleep, as described above.

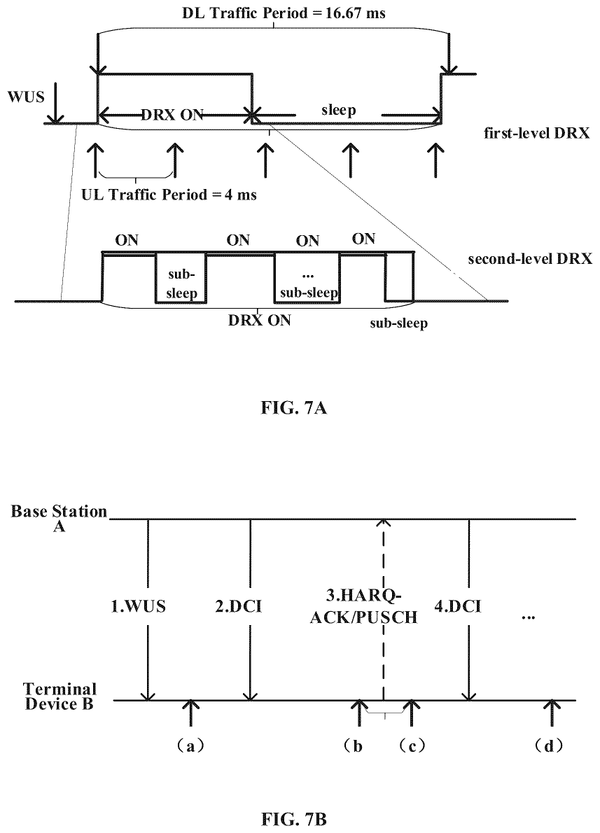

FIG. 7A illustrates an example application of a sub-DRX mechanism according to an embodiment of the present disclosure. Using entertainment and gaming as examples of XR services, its downlink transmission includes video content, and its uplink transmission includes user-side control instructions. As shown in FIG. 7A, using a frame rate of 60 fps video content as an example, an interval between adjacent transmissions in downlink is 16.67 ms. In this example, an interval between adjacent transmissions in uplink is 4 ms. If only the first-level DRX is configured with an activation duration of 8 ms and a DRX cycle of 16 ms, PDCCH monitoring is not required at least during the first 4 ms of the activation duration in this example. It is to be understood that, by configuring the second-level DRX, sleep is entered during at least part of the first 4 ms of the activation duration of the first-level DRX, thereby improving energy saving performance of the terminal device.

FIG. 7B illustrates specific operations of a base station and a terminal device corresponding to FIG. 7A. As shown in FIG. 7B, at operation 1, a base station A sends a wake-up signal WUS to a terminal device B. Accordingly, at (a), the terminal device B detects the WUS, obtains a first-level DRX parameter therefrom, and enters a first-level activation duration accordingly. At operation 2, the base station A sends DCI to the terminal device B. Accordingly, the terminal device B receives the DCI during the first-level activation duration and obtains a second-level DRX parameter therefrom. Based on the second-level DRX parameter, the terminal device B is in the second-level sleep duration between (b) and (c) and enters sleep. During this period, at operation 3, the terminal device B may send a HARQ eedback for downlink transmission or perform uplink transmission. At (d), the second-level sleep duration expires and the terminal device B wakes up. At operation 4, the base station A sends DCI to the terminal device B again. The DCI may carry a new second-level DRX parameter, and the terminal device B may repeatedly sleep and wake up based on the new parameter until the first-level activation duration expires. Once the first-level activation duration expires, the terminal device B may enter sleep based on the first-level DRX.

In an embodiment, during PDCCH monitoring, based on whether a DCI format type for monitoring is known, a monitoring enhancement scheme may be used to reduce monitoring power consumption. This includes monitoring on a reduced search space set or blind detection for a reduced number of blind detections. In an example, if scheduling or unicast DCI is already known, monitoring and blind detection may be performed only on a USS and a type3 CSS. In an example, if it is known to have a format same to or different from some already decoded DCI, blind detection is performed in a corresponding search space only on PDCCH candidates that have a same format as or a different format from the already decoded DCI.

### Example Method

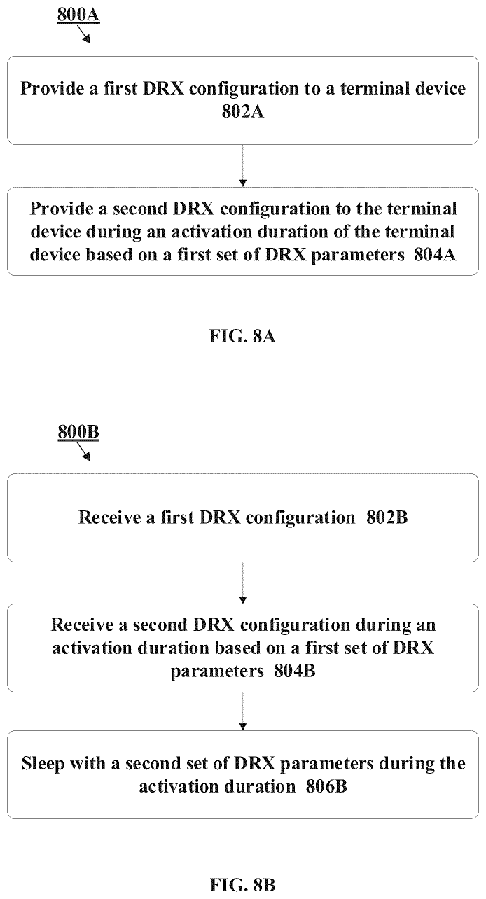

FIG. 8A illustrates a first example method for communication according to an embodiment of the present disclosure. The method may be performed by an electronic device 300A or a corresponding base station. As shown in FIG. 8A, the method 800A may include: providing a first DRX configuration to a terminal device, the first DRX configuration being used to cause the terminal device to activate and/or sleep with a first set of DRX parameters (block 802A). The method may further include: providing a second DRX configuration to the terminal device during an activation duration of the terminal device based on the first set of DRX parameters, the second DRX configuration being used to cause the terminal device to sleep with a second set of DRX parameters during an activation duration based on the first DRX configuration (block 804A).Further details of the method may be understood with reference to the description above with respect to the electronic device 300A or the base station.

In an embodiment, the method further includes: providing a predefined DRX parameter set to the terminal device through higher layer signaling, and providing the second DRX configuration to the terminal device through lower layer signaling, where the second DRX configuration is used to indicate the second set of DRX parameters from the predefined DRX parameter set, where whether the second DRX configuration is enabled is indicated by higher layer signaling or lower layer signaling.

In an embodiment, the second DRX configuration is used to carry the second set of DRX parameters per se or identification information of the second set of DRX parameters.

In an embodiment, the second set of DRX parameters includes at least one of the following: one or more sleep durations; or a number of times for sleep.

In an embodiment, the lower layer signaling is downlink control information DCI, and the processing circuit is further configured to provide the second DRX configuration by using one or more bits in a DCI format, the one or more bits including at least one of the following: a new bit in the DCI format; a reserved bit in the DCI format; or a used bit in the DCI format.

In an embodiment, the used bit in the DCI format is a bit used for indicating time domain resource allocation.

In an embodiment, the second set of DRX parameters includes at least one of a sleep duration or a sub-DRX cycle.

FIG. 8B illustrates a second example method for communication according to an embodiment of the present disclosure. The method may be performed by an electronic device 300B or a corresponding terminal device. As shown in FIG. 8B, the method 800B may include (block 802B). The method may further include (block 804B). The method may further include (block 806B). Further details of the method may be understood with reference to the description above with respect to the electronic device 300B or the terminal device.

In an embodiment, the method further includes: receiving a predefined DRX parameter set through higher layer signaling, and receiving the second DRX configuration through lower layer signaling, where the second DRX configuration is used to indicate the second set of DRX parameters from the predefined DRX parameter set, where whether the second DRX configuration is enabled is indicated by higher layer signaling or lower layer signaling.

In an embodiment, the second DRX configuration is used to carry the second set of DRX parameters per se or identification information of the second set of DRX parameters.

In an embodiment, the second set of DRX parameters includes at least one of the following: one or more sleep durations; or a number of times for sleep.

In an embodiment, the lower layer signaling is downlink control information DCI, and the processing circuit is further configured to obtain the second DRX configuration from one or more bits in a DCI format, the one or more bits including at least one of the following: a new bit in the DCI format; a reserved bit in the DCI format; or a used bit in the DCI format.

In an embodiment, the used bit in the DCI format is used for indicating time domain resource allocation, and the processing circuit is further configured to sleep during a period of time corresponding to a time domain resource.

In an embodiment, the method further includes: performing physical downlink control channel PDCCH monitoring in a reduced search space or monitoring a PDCCH with a specific DCI format in a search space.

In an embodiment, the second set of DRX parameters includes at least one of a sleep duration or a sub-DRX cycle.

Various exemplary electronic devices and methods according to embodiments of the present disclosure have been described above. It should be understood that the operations or functions of these electronic devices may be combined with each other to achieve more or less operations or functions than described. The operational steps of the methods may also be combined with each other in any suitable order, so that similarly more or fewer operations are achieved than described.

It should be understood that the machine-executable instructions in the machine-readable storage medium or program product according to the embodiments of the present disclosure can be configured to perform operations corresponding to the device and method embodiments described above. When referring to the above device and method embodiments, the embodiments of the machine-readable storage medium or the program product are clear to those skilled in the art, and therefore description thereof will not be repeated herein. A machine-readable storage media and a program product for carrying or including the above-described machine-executable instructions also fall within the scope of the present disclosure. Such storage medium can include, but is not limited to, a floppy disk, an optical disk, a magneto-optical disk, a memory card, a memory stick, and the like. In addition, it should be understood that the above series of processing and devices may alternatively be implemented by software and/or firmware.

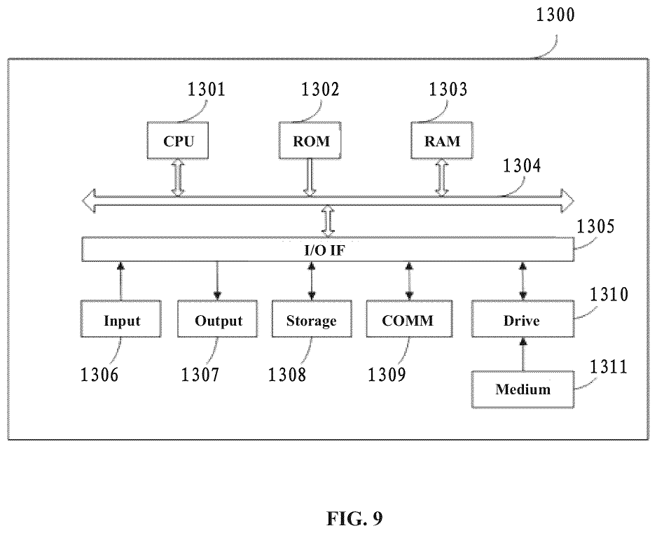

In addition, it should be understood that the above series of processing and devices may alternatively be implemented by software and/or firmware. In the case of implementation by software and/or firmware, a program constituting the software is installed from a storage medium or a network to a computer having a dedicated hardware configuration, such as a general-purpose computer 1300 shown in FIG. 9. When various programs are installed, the computer is capable of performing various functions and so on. FIG. 9 is an example block diagram of a computer capable of being implemented as a terminal device or base station according to an embodiment of the present disclosure.

In FIG. 9, a central processing unit (CPU) 1301 executes various processing based on a program stored in a read-only memory (ROM) 1302 or a program loaded from a storage portion 1308 to a random access memory (RAM) 1303. The RAM 1303 also stores data required for executing various processing and the like by the CPU 1301 when necessary.

The CPU 1301, the ROM 1302, and the RAM 1303 are connected with each other via a bus 1304. An input/output port 1305 is also connected to the bus 1304.

The following components are connected to the input/output port 1305: an input part 1306, including a keyboard, a mouse, and the like; an output part 1307, including a display such as a cathode-ray tube (CRT) and a liquid crystal display (LCD), a speaker, and the like; a storage part 1308, including a hard disk and the like; and a communication part 1309, including a network interface card such as a LAN card or a modem. The communication part 1309 performs communication processing via a network such as the Internet.

Based on needs, a drive 1310 is also connected to the input/output port 1305. A removable medium 1311 such as a magnetic disk, an optical disk, a magneto-optical disk, a semiconductor memory, or the like is mounted on the drive 1310 when necessary, so that a computer program read therefrom is installed in the storage part 1308 when necessary.

In a case that the foregoing series of processing are implemented by software, programs constituting the software are installed from a network such as the Internet or a storage medium such as the removable medium 1311.

Those skilled in the art should understand that such a storage medium is not limited to the removable medium 1311 shown in FIG. 9, in which the program is stored and distributed independent from a device to provide the program for users. For example, the removable medium 1311 includes a magnetic disk (including a floppy disk (registered trademark)), an optical disc (including a compact disk read-only memory (CD-ROM) and a digital versatile disk (DVD)), a magneto-optical disc (including a mini disk (MD) (registered trademark)), and a semiconductor memory. Alternatively, the storage medium may be the ROM 1302, a hard disk included in the storage part 1308, or the like, in which the program is stored, and may be distributed to users along with a device including the storage medium.

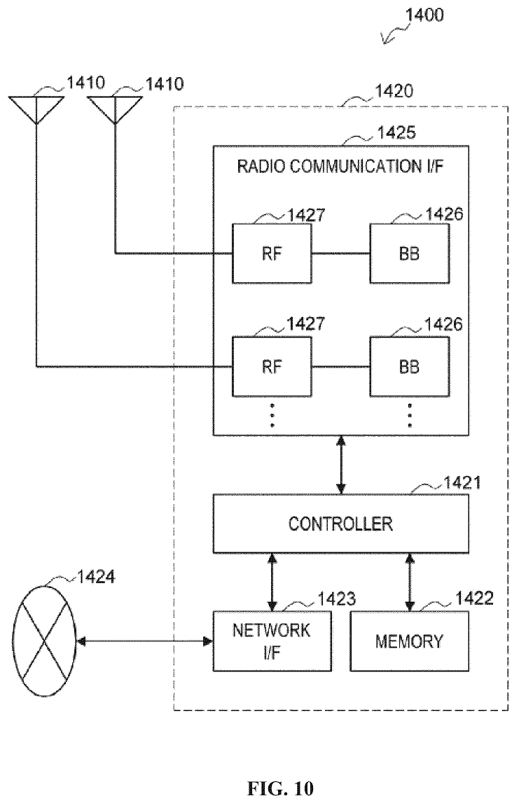

Use cases according to the present disclosure will be described below with reference to FIGS. 10 to 13.

### Use Cases for the Base Station

### First Use Case

FIG. 10 is a block diagram illustrating a first example of a schematic configuration of a gNB which can apply the technology of the present disclosure. The gNB 1400 includes a plurality of antennas 1410 and a base station device 1420. The base station device 1420 and each antenna 1410 may be connected to each other via an RF cable. In one implementation, the gNB 1400 (or base station device 1420) herein may correspond to the electronic device 300A described above.

Each of the antennas 1410 includes a single or multiple antenna elements (such as multiple antenna elements included in a multiple input and multiple output (MIMO) antenna), and is used for the base station device 1420 to transmit and receive radio signals. As shown in FIG. 10, the gNB 1400 may include multiple antennas 1410. For example, multiple antennas 1410 may be compatible with multiple frequency bands used by the gNB 1400.

The base station device 1420 includes a controller 1421, a memory 1422, a network interface 1423, and a radio communication interface 1425.

The controller 1421 may be, for example, a CPU or a DSP, and operates various functions of higher layers of the base station device 1420. For example, controller 1421 generates data packets from data in signals processed by the radio communication interface 1425, and transfers the generated packets via the network interface 1423. The controller 1421 can bundle data from multiple baseband processors to generate the bundled packets, and transfer the generated bundled packets. The controller 1421 may have logic functions of performing control such as radio resource control, radio bearer control, mobility management, admission control, and scheduling. This control may be performed in corporation with a gNB or a core network node in the vicinity. The memory 1422 includes a RAM and a ROM, and stores a program that is executed by the controller 1421 and various types of control data (such as a terminal list, transmission power data, and scheduling data).

The network interface 1423 is a communication interface for connecting the base station device 1420 to the core network 1424. The controller 1421 may communicate with a core network node or another gNB via the network interface 1423. In this case, the gNB 1400 and the core network node or other gNBs may be connected to each other through a logical interface (such as an S1 interface and an X2 interface). The network interface 1423 may also be a wired communication interface or a radio communication interface for radio backhaul lines. If the network interface 1423 is a radio communication interface, the network interface 1423 may use a higher frequency band for radio communication than a frequency band used by the radio communication interface 1425.

The radio communication interface 1425 supports any cellular communication schemes (such as Long Term Evolution (LTE) and LTE-Advanced), and provides, via the antenna 1410, radio connection to a terminal located in a cell of the gNB 1400. The radio communication interface 1425 may typically include, for example, a baseband (BB) processor 1426 and a RF circuit 1427. The BB processor 1426 may perform, for example, encoding/decoding, modulation/demodulation, and multiplexing/demultiplexing, and performs various types of signal processing of layers (such as L1, Medium Access Control (MAC), Radio Link Control (RLC), and Packet Data Convergence Protocol (PDCP)).Instead of the controller 1421, the BB processor 1426 may have a part or all of the above-described logic functions. The BB processor 1426 may be a memory that stores a communication control program, or a module that includes a processor configured to execute the program and a related circuit. Updating the program may allow the functions of the BB processor 1426 to be changed. The module may be a card or a blade that is inserted into a slot of the base station device 1420. Alternatively, the module may also be a chip that is mounted on the card or the blade. Meanwhile, the RF circuit 1427 may include, for example, a mixer, a filter, and an amplifier, and transmits and receives radio signals via the antenna 1410. Although FIG. 10 illustrates the example in which one RF circuit 1427 is connected to one antenna 1410, the present disclosure is not limited to thereto; rather, one RF circuit 1427 may connect to a plurality of antennas 1410 at the same time.

As illustrated in FIG. 10, the radio communication interface 1425 may include the multiple BB processors 1426. For example, the multiple BB processors 1426 may be compatible with multiple frequency bands used by gNB 1400. As illustrated in FIG. 10, the radio communication interface 1425 may include the multiple RF circuits 1427. For example, the multiple RF circuits 1427 may be compatible with multiple antenna elements. Although FIG. 10 illustrates the example in which the radio communication interface 1425 includes the multiple BB processors 1426 and the multiple RF circuits 1427, the radio communication interface 1425 may also include a single BB processor 1426 or a single RF circuit 1427.

### Second Use Case

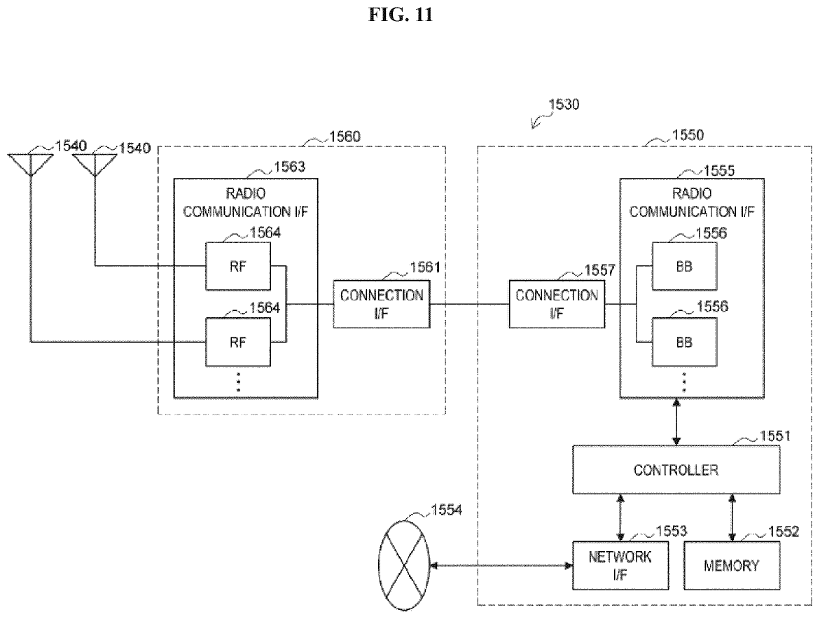

FIG. 11 is a block diagram illustrating a second example of a schematic configuration of a gNB which can apply the technology of the present disclosure. The gNB 1530 includes a plurality of antennas 1540, a base station device 1550, and an RRH 1560. The RRH 1560 and each antenna 1540 may be connected to each other via an RF cable. The base station device 1550 and the RRH 1560 may be connected to each other via a high speed line such as a fiber optic cable. In one implementation, the gNB 1530 (or base station device 1550) herein may correspond to the electronic device 300A described above.

Each of the antennas 1540 includes a single or multiple antenna elements such as multiple antenna elements included in a MIMO antenna and is used for the RRH 1560 to transmit and receive radio signals. As shown in FIG. 11, the gNB 1530 may include multiple antennas 1540. For example, multiple antennas 1540 may be compatible with multiple frequency bands used by the gNB 1530.

The base station device 1550 includes a controller 1551, a memory 1552, a network interface 1553, a radio communication interface 1555, and a connection interface 1557. The controller 1551, the memory 1552, and the network interface 1553 are the same as the controller 1421, the memory 1422, and the network interface 1423 described with reference to FIG. 10.

The radio communication interface 1555 supports any cellular communication scheme (such as LTE and LTE-Advanced) and provides radio communication to terminals positioned in a sector corresponding to the RRH 1560 via the RRH 1560 and the antenna 1540. The radio communication interface 1555 may typically include, for example, a BB processor 1556. The BB processor 1556 is the same as the BB processor 1426 described with reference to FIG. 10, except that the BB processor 1556 is connected to the RF circuit 1564 of the RRH 1560 via the connection interface 1557. As illustrated in FIG. 11, the radio communication interface 1555 may include the multiple BB processors 1556. For example, the multiple BB processors 1556 may be compatible with multiple frequency bands used by gNB 1530. Although FIG. 11 illustrates the example in which the radio communication interface 1555 includes multiple BB processors 1556, the radio communication interface 1555 may also include a single BB processor 1556.

The connection interface 1557 is an interface for connecting the base station device 1550 (radio communication interface 1555) to the RRH 1560. The connection interface 1557 may also be a communication module for communication in the above-described high speed line that connects the base station device 1550 (radio communication interface 1555) to the RRH 1560.

The RRH 1560 includes a connection interface 1561 and a radio communication interface 1563.

The connection interface 1561 is an interface for connecting the RRH 1560 (radio communication interface 1563) to the base station device 1550. The connection interface 1561 may also be a communication module for communication in the above-described high speed line.

The radio communication interface 1563 transmits and receives radio signals via the antenna 1540. The radio communication interface 1563 may typically include, for example, the RF circuitry 1564. The RF circuit 1564 may include, for example, a mixer, a filter, and an amplifier, and transmits and receives radio signals via the antenna 1540. Although FIG. 11 illustrates the example in which one RF circuit 1564 is connected to one antenna 1540, the present disclosure is not limited to thereto; rather, one RF circuit 1564 may connect to a plurality of antennas 1540 at the same time.

As illustrated in FIG. 11, the radio communication interface 1563 may include the multiple RF circuits 1564. For example, the multiple RF circuits 1564 may support multiple antenna elements. Although FIG. 11 illustrates the example in which the radio communication interface 1563 includes the multiple RF circuits 1564, the radio communication interface 1563 may also include a single RF circuit 1564.

### Use Cases for the Terminal Device

First Use Case

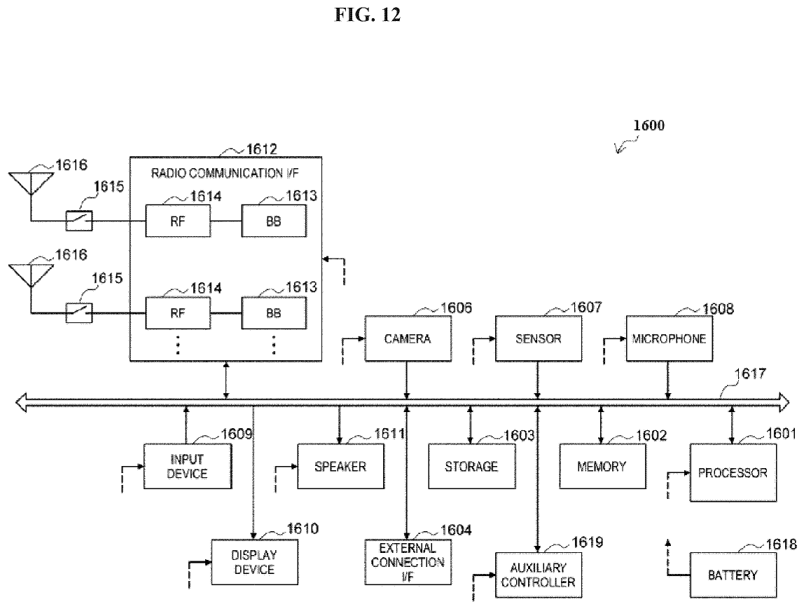

FIG. 12 is a block diagram illustrating an example of a schematic configuration of a smartphone 1600 which can apply the technology of the present disclosure. A smartphone 1600 includes a processor 1601, a memory 1602, a storage device 1603, an external connection interface 1604, a camera device 1606, a sensor 1607, a microphone 1608, an input device 1609, a display device 1610, a speaker 1611, a radio communication interface 1612, one or more antenna switches 1615, one or more antennas 1616, a bus 1617, a battery 1618, and an auxiliary controller 1619. In an implementation, the smartphone 1600 (or the processor 1601) herein may correspond to the electronic device 300B described above.

The processor 1601 may be, for example, a CPU or a system on a chip (SoC), and controls functions of the application layer and other layers of the smartphone 1600. The memory 1602 includes a RAM and a ROM, and stores a program that is executed by the processor 1601. The storage device 1603 may include a storage medium such as a semiconductor memory and a hard disk. The external connection interface 1604 is an interface for connecting an external device (for example, a memory card and a universal serial bus (USB) device) to the smartphone 1600.

The camera device 1606 includes an image sensor (for example, a charge coupled device (CCD) and a complementary metal oxide semiconductor (CMOS)), and generates a captured image. The sensor 1607 may include a set of sensors, such as a measurement sensor, a gyro sensor, a geomagnetic sensor, and an acceleration sensor. The microphone 1608 converts the sound input of the smartphone 1600 into an audio signal. The input device 1609 includes, for example, a touch sensor configured to detect touches on the screen of the display device 1610, a keypad, a keyboard, buttons, or switches, and receives input operations or information of a user. The display device 1610 includes a screen (for example, a liquid crystal display (LCD) and an organic light emitting diode (OLED) display), and displays output images of the smartphone 1600. The speaker 1611 converts output audio signals of the smartphone 1600 into sound.

The radio communication interface 1612 supports any cellular communication scheme (such as LTE, LTE-Advanced, and NR) and performs radio communication. The radio communication interface 1612 may typically include, for example, a BB processor 1613 and an RF circuit 1614. The BB processor 1613 may perform, for example, encoding/decoding, modulation/demodulation, and multiplexing/demultiplexing, and performs various types of signal processing for radio communication. Meanwhile, the RF circuit 1614 may include, for example, a mixer, a filter, and an amplifier, and transmits and receives radio signals via the antenna 1616. The radio communication interface 1612 may be a chip module on which the BB processor 1613 and the RF circuit 1614 are integrated. As shown in FIG. 12, the radio communication interface 1612 may include multiple BB processors 1613 and multiple RF circuits 1614. Although FIG. 12 illustrates the example in which the radio communication interface 1612 includes the multiple BB processors 1613 and the multiple RF circuits 1614, the radio communication interface 1612 may also include a single BB processor 1613 or a single RF circuit 1614.

In addition to a cellular communication scheme, the radio communication interface 1612 can support other types of radio communication schemes, such as a short-range wireless communication scheme, a near-field communication scheme, and a wireless local area network (LAN) scheme. In this case, the radio communication interface 1612 may include the BB processor 1613 and the RF circuit 1614 as to each radio communication scheme.

Each of the antenna switches 1615 switches the connection destination of the antenna 1616 among multiple circuits (for example, circuits for different radio communication schemes) included in the radio communication interface 1612.

Each of the antennas 1616 includes one or more antenna elements (such as multiple antenna elements included in a MIMO antenna), and is used for the radio communication interface 1612 to transmit and receive radio signals. As shown in FIG. 12, the smartphone 1600 may include multiple antennas 1616. Although FIG. 12 illustrates an example in which the smartphone 1600 includes multiple antennas 1616, the radio communication interface 1600 may alternatively include a single antenna 1616.

In addition, the smartphone 1600 may include the antennas 1616 for every radio communication scheme. In this case, the antenna switch 1615 can be removed from configuration of the smartphone 1600.

The bus 1617 connects the processor 1601, the memory 1602, the storage device 1603, the external connection interface 1604, the camera device 1606, the sensor 1607, the microphone 1608, the input device 1609, the display device 1610, the speaker 1611, the radio communication interface 1612, and the auxiliary controller 1619. The battery 1618 provides power for various blocks of the smartphone 1600 illustrated in FIG. 12 via feeders, and the feeders are partially expressed as dashed lines in the figure. The auxiliary controller 1619, for example, operates the minimum necessary functions of the smartphone 1600 in sleep mode.

### Second Use Case

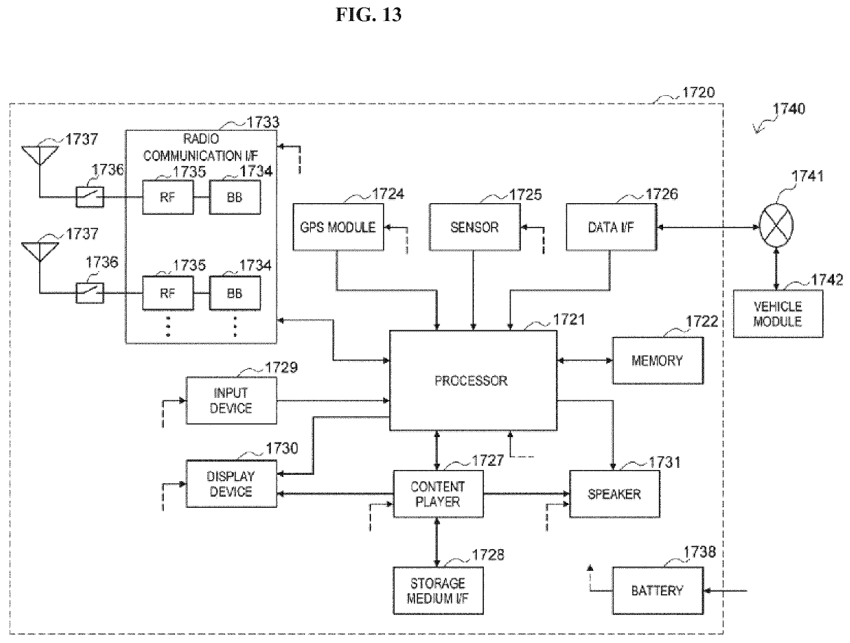

FIG. 13 is a block diagram illustrating an example of a schematic configuration of a car navigation device 1720 which can apply the technology of the present disclosure. A car navigation device 1720 includes a processor 1721, a memory 1722, a global positioning system (GPS) 1724, a sensor 1725, a data interface 1726, a content player 1727, a storage medium interface 1728, an input device 1729, a display device 1730, a speaker 1731, a radio communication interface 1733, one or more antenna switches 1736, one or more antennas 1737, and a battery 1738. In an implementation, the car navigation device 1720 (or the processor 1721) herein may correspond to the electronic device 300B described above.

The processor 1721 may be, for example, a CPU or a SoC, and controls the navigation function and other functions of the car navigation device 1720. The memory 1722 includes a RAM and a ROM, and stores a program that is executed by the processor 1721.

The GPS module 1724 performs measurement on a location (such as a latitude, a longitude, and an altitude) of the car navigation device 1720 by using GPS signals received from GPS satellites. The sensor 1725 may include a set of sensors, such as a gyro sensor, a geomagnetic sensor, and an air pressure sensor. The data interface 1726 is connected to, for example, an in-vehicle network 1741 via a terminal not shown, and acquires data generated by the vehicle (such as vehicle speed data).

The content player 1727 plays back content stored in a storage medium (such as a CD and a DVD), which is inserted into the storage medium interface 1728. The input device 1729 includes, for example, a touch sensor configured to detect touches on the screen of the display device 1730, buttons, or switches, and receives input operations or information of a user. The display device 1730 includes a screen, for example, an LCD or OLED screen, and displays images for the navigation function or playback content. The speaker 1731 outputs the sound for the navigation function or playback content.

The radio communication interface 1733 supports any cellular communication scheme (such as LTE, LTE-Advanced, and NR) and performs radio communication. The radio communication interface 1733 may typically include, for example, a BB processor 1734 and an RF circuit 1735. The BB processor 1734 may perform, for example, encoding/decoding, modulation/demodulation, and multiplexing/demultiplexing, and performs various types of signal processing for radio communication. Meanwhile, the RF circuit 1735 may include, for example, a mixer, a filter, and an amplifier, and transmits and receives radio signals via the antenna 1737. The radio communication interface 1733 may alternatively be a chip module on which the BB processor 1734 and the RF circuit 1735 are integrated. As shown in FIG. 13, the radio communication interface 1733 may include multiple BB processors 1734 and multiple RF circuits 1735. Although FIG. 13 illustrates the example in which the radio communication interface 1733 includes the multiple BB processors 1734 and the multiple RF circuits 1735, the radio communication interface 1733 may also include a single BB processor 1734 or a single RF circuit 1735.

In addition to a cellular communication scheme, the radio communication interface 1733 can support other types of radio communication schemes, such as a short-range wireless communication scheme, a near-field communication scheme, and a wireless LAN scheme. In this case, the radio communication interface 1733 may include the BB processor 1734 and the RF circuit 1735 as to each radio communication scheme.

Each of the antenna switches 1736 switches the connection destination of the antenna 1737 among multiple circuits (for example, circuits for different radio communication schemes) included in the radio communication interface 1733.

Each of the antennas 1737 includes one or more antenna elements (such as multiple antenna elements included in a MIMO antenna), and is used for the radio communication interface 1733 to transmit and receive radio signals. As shown in FIG. 13, the car navigation device 1720 may include multiple antennas 1737. Although FIG. 13 illustrates an example in which the car navigation device 1720 includes multiple antennas 1737, the car navigation device 1720 may alternatively include a single antenna 1737.

In addition, the car navigation device 1720 may include the antenna 1737 for every radio communication scheme. In this case, the antenna switch 1736 can be removed from configuration of the car navigation device 1720.

The battery 1738 provides power for various blocks of the car navigation device 1720 illustrated in FIG. 13 via feeders, and the feeders are partially expressed as dashed lines in the figure. The battery 1738 accumulates power supplied by the vehicle.

The technology of the present disclosure may also be implemented as an in-vehicle system (or vehicle) 1740 including one or more blocks of the car navigation device 1720, the in-vehicle network 1741, and a vehicle module 1742. The vehicle module 1742 generates vehicle data (such as vehicle speed, engine speed, and failure information), and outputs the generated data to the in-vehicle network 1741.

It should be understood that the following example implementations may be used to implement the technical solutions of the present disclosure.

1. An electronic device for a base station side, the electronic device including a processing circuit configured to:
provide a first discontinuous reception (DRX) configuration to a terminal device, the first DRX configuration being used to cause the terminal device to activate and sleep with a first set of DRX parameters; and
during an activation duration of the terminal device based on the first set of DRX parameters, providing a second DRX configuration to the terminal device, the second DRX configuration being used to cause the terminal device to sleep with a second set of DRX parameters during the activation duration.

2. The electronic device of clause 1, where the processing circuit is further configured to:
provide a predefined DRX parameter set to the terminal device through higher layer signaling, and provide the second DRX configuration to the terminal device through lower layer signaling,
where the second DRX configuration is used to indicate the second set of DRX parameters from the predefined DRX parameter set,
where whether the second DRX configuration is enabled is indicated by higher layer signaling or lower layer signaling.

3. The electronic device of clause 2, where providing the second DRX configuration to the terminal device through lower layer signaling includes activating the second DRX configuration through a MAC CE and indicating the second DRX configuration through downlink control information (DCI), and/or
where the second DRX configuration is used to carry the second set of DRX parameters per se or identification information of the second set of DRX parameters.

4. The electronic device of clause 1, where the processing circuit is further configured to provide the second DRX configuration to the terminal device through downlink control information (DCI), the second DRX configuration including the second set of DRX parameters per se, and/or
where whether the second DRX configuration is enabled is indicated by higher layer signaling or DCI.

5. The electronic device of clause 3 or 4, where the second set of DRX parameters includes at least one of the following:
offset value, indicating an offset time from receiving the second set of DRX parameters to entering sleep;
one or more sleep durations;
one or more DRX cycles; or
a number of times for sleep.

6. The electronic device of clause 3 or 4, where the processing circuit is further configured to provide the second DRX configuration by using one or more bits in a DCI format, the one or more bits including at least one of the following:
a new bit in the DCI format;
a reserved bit in the DCI format; or
a used bit in the DCI format.

7. The electronic device of clause 6, where the used bit in the DCI format is a bit used for indicating time domain resource allocation or used for indicating the offset value.

8. An electronic device for a terminal device side, the electronic device including a processing circuit configured to:
receive a first discontinuous reception (DRX) configuration, the first DRX configuration being used to cause the terminal device to activate and sleep with a first set of DRX parameters;
receive a second DRX configuration during an activation duration based on the first set of DRX parameters; and
sleep with a second set of DRX parameters during the activation duration.

9. The electronic device of clause 8, where the processing circuit is further configured to:
receive a predefined DRX parameter set through higher layer signaling, and receive the second DRX configuration through lower layer signaling,
where the second DRX configuration is used to indicate the second set of DRX parameters from the predefined DRX parameter set,
where whether the second DRX configuration is enabled is indicated by higher layer signaling or lower layer signaling.

10. The electronic device of clause 9, where receiving the second DRX configuration through lower layer signaling includes receiving the second DRX configuration through downlink control information (DCI), the second DRX configuration being activated through MAC CE, and/or
where the second DRX configuration is used to carry the second set of DRX parameters per se or identification information of the second set of DRX parameters.

11. The electronic device of clause 8, where the processing circuit is further configured to receive the second DRX configuration through downlink control information (DCI), the second DRX configuration including the second set of DRX parameters per se, and/or
where whether the second DRX configuration is enabled is indicated by higher layer signaling or DCI.

12. The electronic device of clause 10 or 11, where the second set of DRX parameters includes at least one of the following:
offset value, indicating an offset time from receiving the second set of DRX parameters to entering sleep;
one or more sleep durations;
one or more DRX cycles; or
a number of times for sleep.

13. The electronic device of clause 8, where the processing circuit is further configured to obtain the second DRX configuration from one or more bits in a DCI format, the one or more bits including at least one of the following:
a new bit in the DCI format;
a reserved bit in the DCI format; or
a used bit in the DCI format.

14. The electronic device of clause 11, where the used bit in the DCI format is used for indicating time domain resource allocation, and the processing circuit is further configured to sleep during a period of time corresponding to a time domain resource, or sleep after a time corresponding to the time domain resource which is used as an offset value.

15. A communication method, including:
providing a first discontinuous reception (DRX) configuration to a terminal device, the first DRX configuration being used to cause the terminal device to activate and sleep with a first set of DRX parameters; and
during an activation duration of the terminal device based on the first set of DRX parameters, providing a second DRX configuration to the terminal device, the second DRX configuration being used to cause the terminal device to sleep with a second set of DRX parameters during the activation duration.

16. A communication method, including:
receiving a first discontinuous reception (DRX) configuration, the first DRX configuration being used to cause a terminal device to activate and sleep with a first set of DRX parameters;
receiving a second DRX configuration during an activation duration based on the first set of DRX parameters; and
sleeping with a second set of DRX parameters during the activation duration.

17. A computer-readable storage medium having executable instructions stored thereon, which executable instructions, when executed by one or more processors, cause implementation of operations of the method according to any one of clauses 15 or 16.

18. A computer program product, wherein the computer program product comprises instructions which, when executed by a computer, cause implementation of the method according to any one of clauses 15 or 16.

The exemplary embodiments of the present disclosure have been described above with reference to the drawings, but the present disclosure is of course not limited to the above examples. Those skilled in the art can obtain various changes and modifications within the scope of the appended claims, and it should be understood that these changes and modifications will naturally fall within the technical scope of the present disclosure.

For example, a plurality of functions included in one unit in the above embodiments may be implemented by separate devices. Alternatively, the multiple functions implemented by the multiple units in the above embodiments may be implemented by separate devices, respectively. In addition, one of the above functions can be realized by multiple units. Needless to say, such a configuration is included in the technical scope of the present disclosure.

In this specification, the steps described in the flowchart include not only processes performed in time series in the described order, but also processes performed in parallel or individually rather than necessarily in time series. In addition, even in the steps processed in time series, needless to say, the order can be changed appropriately.

Although the present disclosure and its advantages have been described in detail, it should be understood that various modifications, replacements, and changes can be made without departing from the spirit and scope of the present disclosure as defined by the appended claims. Moreover, the terms “include”, “comprise”, or their any other variant in the embodiments of the present disclosure is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the existence of additional identical elements in the process, method, article, or apparatus that includes the element.

1. An electronic device for a base station side, the electronic device comprising a processing circuit configured to:
provide a first discontinuous reception (DRX) configuration to a terminal device, the first DRX configuration being used to cause the terminal device to activate and sleep with a first set of DRX parameters; and
during an activation duration of the terminal device based on the first set of DRX parameters, provide a second DRX configuration to the terminal device, the second DRX configuration being used to cause the terminal device to sleep with a second set of DRX parameters during the activation duration.

2. The electronic device of claim 1, wherein the processing circuit is further configured to:
provide a predefined DRX parameter set to the terminal device through higher layer signaling, and provide the second DRX configuration to the terminal device through lower layer signaling,
wherein the second DRX configuration is used to indicate the second set of DRX parameters from the predefined DRX parameter set,
wherein whether the second DRX configuration is enabled is indicated by higher layer signaling or lower layer signaling.

3. The electronic device of claim 2, wherein providing the second DRX configuration to the terminal device through lower layer signaling comprises activating the second DRX configuration through a MAC CE and indicating the second DRX configuration through downlink control information (DCI), and/or
wherein the second DRX configuration is used to carry the second set of DRX parameters per se or identification information of the second set of DRX parameters.

4. The electronic device of claim 1, wherein the processing circuit is further configured to provide the second DRX configuration to the terminal device through downlink control information (DCI), the second DRX configuration comprising the second set of DRX parameters per se, and/or
wherein whether the second DRX configuration is enabled is indicated by higher layer signaling or DCI.

5. The electronic device of claim 3, wherein the second set of DRX parameters comprises at least one of the following:
offset value, indicating an offset time from receiving the second set of DRX parameters to entering sleep;
one or more sleep durations;
one or more DRX cycles; or
a number of times for sleep.

6. The electronic device of claim 3, wherein the processing circuit is further configured to provide the second DRX configuration by using one or more bits in a DCI format, the one or more bits comprising at least one of the following:
a new bit in the DCI format;
a reserved bit in the DCI format; or
a used bit in the DCI format.

7. The electronic device of claim 6, wherein the used bit in the DCI format is a bit used for indicating time domain resource allocation or used for indicating the offset value.

8. An electronic device for a terminal device side, the electronic device comprising a processing circuit configured to:
receive a first discontinuous reception (DRX) configuration, the first DRX configuration being used to cause the terminal device to activate and sleep with a first set of DRX parameters;
receive a second DRX configuration during an activation duration based on the first set of DRX parameters; and
sleep with a second set of DRX parameters during the activation duration.

9. The electronic device of claim 8, wherein the processing circuit is further configured to:
receive a predefined DRX parameter set through higher layer signaling, and receive the second DRX configuration through lower layer signaling,
wherein the second DRX configuration is used to indicate the second set of DRX parameters from the predefined DRX parameter set,
wherein whether the second DRX configuration is enabled is indicated by higher layer signaling or lower layer signaling.

10. The electronic device of claim 9, wherein receiving the second DRX configuration through lower layer signaling comprises receiving the second DRX configuration through downlink control information (DCI), the second DRX configuration being activated through MAC CE, and/or
wherein the second DRX configuration is used to carry the second set of DRX parameters per se or identification information of the second set of DRX parameters.

11. The electronic device of claim 8, wherein the processing circuit is further configured to receive the second DRX configuration through downlink control information (DCI), the second DRX configuration comprising the second set of DRX parameters per se, and/or
wherein whether the second DRX configuration is enabled is indicated by higher layer signaling or DCI.

12. The electronic device of claim 10, wherein the second set of DRX parameters comprises at least one of the following:
offset value, indicating an offset time from receiving the second set of DRX parameters to entering sleep;
one or more sleep durations;
one or more DRX cycles; or
a number of times for sleep.

13. The electronic device of claim 8, wherein the processing circuit is further configured to obtain the second DRX configuration from one or more bits in a DCI format, the one or more bits comprising at least one of the following:
a new bit in the DCI format;
a reserved bit in the DCI format; or
a used bit in the DCI format.

14. The electronic device of claim 11, wherein the used bit in the DCI format is used for indicating time domain resource allocation, and the processing circuit is further configured to sleep during a period of time corresponding to a time domain resource, or sleep after a time corresponding to the time domain resource which is used as an offset value.

15. A communication method, comprising:
providing a first discontinuous reception (DRX) configuration to a terminal device, the first DRX configuration being used to cause the terminal device to activate and sleep with a first set of DRX parameters; and
during an activation duration of the terminal device based on the first set of DRX parameters, providing a second DRX configuration to the terminal device, the second DRX configuration being used to cause the terminal device to sleep with a second set of DRX parameters during the activation duration.

16. A communication method, comprising:
receiving a first discontinuous reception (DRX) configuration, the first DRX configuration being used to cause a terminal device to activate and sleep with a first set of DRX parameters;
receiving a second DRX configuration during an activation duration based on the first set of DRX parameters; and
sleeping with a second set of DRX parameters during the activation duration.

17. A computer-readable storage medium having executable instructions stored thereon, which executable instructions, when executed by one or more processors, cause implementation of operations of the method of claim 15.

18. A computer program product, wherein the computer program product comprises instructions which, when executed by a computer, cause implementation of the method of claim 15.

19. A computer-readable storage medium having executable instructions stored thereon, which executable instructions, when executed by one or more processors, cause implementation of operations of the method of claim 16.

20. A computer program product, wherein the computer program product comprises instructions which, when executed by a computer, cause implementation of the method of claim 16.
